(19) United States
(12) Patent Application Publication
(10) Pub. No.: US 2002/0026353 A1
(43) Pub. Date: Feb. 28, 2002

(54) System and method of providing purchase information to consumers relating to advertisements displaying the product

(76) Inventors: Marc Porat, Los Altos, CA (US); Liana Elliott, Palo Alto, CA (US)

Correspondence Address: MCDERMOTT, WILL & EMERY, 600 13th Street, N.W., Washington, DC, 20005-3096, US

(21) Appl. No.: 09/745,181

(22) Filed: Dec. 22, 2000

Related U.S. Application Data
(60) Provisional application No. 60/171,764, filed on Dec. 22, 1999.

(51) Int. Cl. G06F 17/60

(52) U.S. Cl. 705/14

(57) ABSTRACT

Purchase information about a product is provided by identifying products in a print advertisement in a print media source; obtaining purchase information about the product; sorting the product in a database; reproducing the print advertisement in an interactive media source; associating the information about the product to the reproduced advertisement in the interactive media source; and providing the information about the product. The product is identified in the print advertisement by a creator of the print advertisement, and the product can be sorted by purchase information obtained from the creator of the advertisement. Also, the information is provided when a user interacts with the reproduced advertisement by electronically indicating one of the products on the reproduced print advertisement using an interactive communications channel.

### FIELD OF THE INVENTION

The present invention relates to providing purchase information to consumers using an interactive communications channel, and more particularly, to a method of providing network-based purchase information based on advertisements displaying the product.

### BACKGROUND OF THE INVENTION

Every popular magazine contains editorial and advertising copy and images that portray attractive fashion and lifestyle “looks”. This content, often produced at a high cost by brands and their advertising agencies, are designed to drive readers to purchase the brand or product being marketed. Typically, a brand promotes a look that incorporates some or all of its products into the image. However, during the creation of the advertisement, the advertising agency may include accessories from other brands, which are necessary to complete the look. These accessories, for example in an advertisement for apparel, are not necessarily limited to items such as jewelry, watches, or shoes. Other accessories, such as physical settings, for example a beach resort, and props, for example a sports car, can also be used to complete the look.

The look produced by the advertising agency, therefore, can produce not only a purchasing urge in consumer for a particular brand being advertised, but can also a purchasing urge for other items displayed within the advertisement to create the desired look. However, the time during which the urge in a consumer is the highest to obtain these products is immediately when the consumer sees the advertisement. If the consumer cannot immediately locate and purchase the products seen in the advertisement, that selling moment is usually lost.

To date, there has been no easy way for a consumer to find the products that make up a look in an advertisement. Many reader service pages are incomplete or out of date. 1-800 phone numbers are not typically included on brand advertising, and even if they are, operators are often unable to answer consumer's questions about the product in the advertisement. Additionally, merchants may only buy a limited selection of a product line and often do not have the exact product featured in the advertisement. Furthermore, thee is a large class of products that many consumers are uncomfortable buying online. These products are typically items where the look, feel, and fit are important to the purchasing decision.

The advent and popularity of the Internet as an environment for commerce has created opportunities for communication between businesses and consumers that have previously been unknown and unexplored. In the apparel section, however, 97% of all goods are still sold in retail stores. A reason for the lack of success in marketing products such as apparel online is that there are certain products that the consumer has to touch, feel, smell, try on, show a friend, and are simply undesirable as an online purchase. Current internet-enabled “e-tailing” involve having stores create online catalogs and order forms available for consumers to purchase goods. This model is referred to as business-to-consumer. Other models include business-to-business, but this model completely ignores the consumer. Online auctions and similar models have been recently introduced and can be classified as a consumer-to-consumer model. However, these business models fail to take advantage of the selling moments created when a consumer sees a look in an advertisement.

An example of a business to consumer web site is located at www.ultigo.com. This web site, launched in November of 2000, but has since gone out of business, enables a reader to interact with products and services featured in editorial pages of off-line publications. This web site, however, is exclusive to magazines, and does not serve a particular brand or merchant. Another example of a web site, www.found.com, offers a database of store inventories intended to allow branded manufacturers and retailers to leverage offline bricks-and-mortar assets. Another web site, www.like.com, identifies celebrities' favorite items in categories, such as movies, books, music and fashion. Still another web site, www.style.com, has announced a plan to drive consumers of prestigious fashion brands to the internet to complete a transaction.

Although these web sites provide consumers an opportunity to purchase products online or are able to direct the consumers to merchants selling the products, these web sites have not completely harnessed the value of the advertising created for these particular products. Furthermore, none of these web sites taken advantage of the look created in the advertisement to generate sales for products not be specifically marketed in the advertisement. Accordingly, a need exists for an improved method of providing purchase information to consumers about products in an advertisement that can generate selling opportunities when the buying urge is greatest in the consumer.

### SUMMARY OF THE INVENTION

These and other needs are met by embodiments of the present invention which provide a method for providing information about a product. The method includes the steps of identifying products in an advertisement within a first media source; obtaining information about the product; sorting the product in a database by the information obtained; reproducing the advertisement in an interactive media source; associating the information about the product to the reproduced advertisement in the interactive media source; and providing the information about the product when a user interacts with the reproduced advertisement. The product being displayed can be either goods or services. Also, the product in the advertisement can be identified by a creator of the advertisement. Furthermore, the first media source can be print media, such as a magazine, or video, such as a commercial.

By utilizing an interactive media source, such as the internet, the present invention advantageous provides a user with purchase information about a product when the user views the product in a advertisement from a media source, such-as a magazine. Thus, a network effect is created that links user, advertiser, and merchant in which a look, provided by the advertiser in the advertisement, creates sales to the user for the merchant of products shown in an advertisement. By providing a user with immediate information about products that are used to create a particular look that the user finds to be attractive, the selling moment created by can be realized into a sale at the time when the user's purchasing urge is greatest.

In one aspect of the invention, the user interacts with the reproduced advertisement by electronically indicating the product on the reproduced advertisement. This electronic indication can be by clicking on a mouse while passing an electronic cursor over an image of the product in the reproduced advertisement or by pressing a stylus against a touchpad of a personal digital assistant (PDA), which is displaying the reproduced advertisement.

In another aspect of the invention, the information obtained about the product can include purchase information. This purchase information can include a location of a merchant selling the product; an image of the product; a coupon for the product, a description of the product, price of the product, and availability of the product at a bricks and mortar merchant or an online merchant. The coupon can be delivered to the user via facsimile or an internet-enabled device, and the internet-enabled device can include a computer, a phone, a personal digital assistant, and other wireless devices. The coupon can also be delivered to a merchant selling the product.

In an additional aspect of the invention, the information about the merchant selling the product is selected by choosing a merchant having a closest location to a location preferred by the user. The merchant can also be selected from a list of merchants specifically preferred by the user. Also, the product can be located on the interactive media source by searching according to a brand of the product; according to the first media source; according to a product type; according to a merchant; or according to the advertisement.

In still another aspect of the invention, the information is obtained by the user through an interactive communications channel, such as a network, internet, or 2-way digital cable system. If the interactive communications channel is the internet, the user can access the interactive communications channel via an internet-enabled device, such as a computer, a phone, or a personal digital assistant. Furthermore, the location on the interactive media source of the information can be obtained using an electronically-recognizable identifier associated with the first media source. This identifier can be associated with the advertisement, and examples of identifiers include a barcode and a digital signal.

In an additional implementation of the invention, a data signal in a carrier wave is provided for a user to obtain information about a product. The data signal includes electronic indication signals and product information signals. The electronic indication signals are received by an interactive communications channel interface device from the user, and the electronic indication signals are in reference to a reproduction of the advertisement displayed in an interactive media source. The product information signals are output by the interactive communications channel interface device, and the product information signals are determined by a controller based upon the electronic indication signals received from the user.

In a further implementation of the invention, a computer-implemented system is provided for supplying information about a product displayed in an advertisement in a first media source. The system includes an interactive communications channel interface device, a data storage device, and a controller. The interactive communications channel interface device can receive data from the user and provide information about the product to the user. The data storage device stores the data received from the interactive communications channel and also stores reproductions of the advertisement and information about the product. When stored, the information about the product can be associated with the reproduction of the advertisement. The controller determines the information to be provided to the user based on the data received from the user.

In accord with one implementation of the invention, the interactive communications channel interface device includes an electronic cursor for the user to indicate a particular product. Furthermore, the interactive communications channel interface device can be connected to an internet, a network, and/or a cable system. The interactive communications channel interface device can also be connected to a creator of the advertisement so as to obtain identities of particular products being displayed in advertisements. Additionally, the interactive communications channel interface device can be connected to a merchant to allow the merchant to supply the purchase information about the product.

In yet another embodiment of the invention, a computer readable medium is provided for bearing instructions for supplying information about a product. These instructions are arranged to cause one or more processors, upon execution, to perform the steps of identifying products in an advertisement within a first media source; obtaining information about the product; sorting the product in a database by the information obtained; reproducing the advertisement in an interactive media source; associating the information about the product to the reproduced advertisement in the interactive media source; and providing the information about the product when a user interacts with the reproduced advertisement. The product being displayed can be either goods or services. Also, the product in the advertisement can be identified by a creator of the advertisement. Furthermore, the first media source can be print media, such as a magazine, or video, such as a commercial.

Additional advantages of the present invention will become readily apparent to those skilled in this art from the following detailed description, wherein only the preferred embodiment of the present invention is shown and described, simply by way of illustration of the best mode contemplated for carrying out the present invention. As will be realized, the present invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a flowchart illustrating the operation of one embodiment of the invention.

FIGS. 2-11 show screen displays according to one embodiment of the invention.

FIG. 12 is a flowchart illustrating the operation to another embodiment of the invention.

FIG. 13 is a coupon according to an embodiment of the invention.

FIG. 14 is a block diagram illustrating a computer system upon which an embodiment of the invention may be implemented.

### DETAILED DESCRIPTION OF THE INVENTION

The following terms and acronyms are used throughout the detailed description:

Interactive Communications Channel. A model of interaction in a distributed system in which a node at one location sends a request to a node at another location and waits for a response. An example of such a system is known as a Client-Server system. The requesting node or program is called the “client,” and the node or program which responds to the request is called the “server.” In the context of the World Wide Web (discussed below), the client is a “Web browser” (or simply “browser”) which runs on a computer of a user; the program which responds to browser requests by serving web pages is commonly referred to as a “Web server.” Other examples of interactive communications channels include networks and two-way cable systems.

Media Source: A source of information, for example by television, newspapers, magazines, the internet. As the term is used herein, a media source, in particular, includes sources of images.

Interactive Media Source: A media source that allows interaction with a particular media so as to enable the user to change the content of the information being provided. Illustrative examples of interactive media sources include the internet, two-way cable systems, and certain wireless telephones.

Internet. A collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

World Wide Web (“Web”). Used herein to refer generally to both (i) a distributed collection of interlinked, user-viewable hypertext documents (commonly referred to as web documents or web pages) that are accessible via the internet, and (ii) the client and server software components which provide user access to such documents using standardized Internet protocols. Currently, the primary standard protocol for allowing applications to locate and acquire web documents is HTTP, and the web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a web site corresponds to a particular internet domain name, such as “LookLike.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

HTML (HyperText Markup Language). A standard coding convention and set of codes for attaching presentation and linking attributes to informational content within documents. During a document authoring stage, the HTML codes (referred to as “tags”) are embedded within the informational content of the document. When the web document (or HTML document) is subsequently transferred from a web server to a browser, the codes are interpreted by the browser and used to parse and display the document. Additionally in specifying how the web browser is to display the document, HTML tags can be used to create links to other web documents (commonly referred to as “hyperlinks”).

HTTP (HyperText Transport Protocol). The standard World Wide Web client-server protocol used for the exchange of information (such as HTML documents, and client requests for such documents) between a browser and a web server. HTTP includes a number of different types of messages which can be sent from the client to the server to request different types of server actions. For example, a “GET” message, which has the format GET, causes the server to return the document or file located at the specified URL.

URL (Uniform Resource Locator). An unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

Cookies. A technology that enables a Web server to retrieve information from a user's computer that reveals prior browsing activities of the user. The informational item stored on the user's computer (typically on the hard drive) is commonly referred to as a “cookie.” Many standard web browsers support the use of cookies.

Product. This term is also used interchangeably with the term “item”. A product can be used to referred to both physical items and also to services. For example, physical items can include apparel, fashion accessories, household goods, office goods. Examples of services can include interior decorators, hair styling, and travel.

The invention provides a method and system that converts passive viewers of visual media into active retail users. The invention exploits the power of interactive communications channels, such as the internet, to leverage brands' advertising in visual media sources, such as magazines, to drive users into nearby merchants or stores or into online merchants. This invention provides a crucial link in a huge pre-existing value chain that connects the experience of seeing a product in a magazine to buying the product in the nearest store. This link is a strong network effect between magazine, brand, merchant, and their advertising agencies. The link can also be embedded inside the web sites of affiliated magazines, brands, stores, or affiliated portals.

The invention effectively converts the brand advertising in magazines into a point-of-sale catalog. This link harnesses the best features of advertising agencies, which specialize in creating an image or “look” that creates a buying urge in users, of the internet, which allows users quick and easy to access mass amounts of information, and with merchant, which can provide personal service to users and allow the users to touch and feel the products before buying.

Although the invention is particularly applicable to products in which the “look and feel” of the product is important during the buying decision process, the invention is also applicable to any product displayed in a visual advertisement or discussed in an editorial. For example, a user looking at a fashion advertisement can be commercially interested not only in the clothing, but cosmetics, furnishings, accessories, even the location, such as a hotel resort. Similarly, a user looking at a car advertisement could be interested not only in the car, but also in the clothing worn by the models.

### EXAMPLE 1

In one example, applicable to print media, such as magazines, the web site can be accessed directly by the user. The database, which is accessible by the web site, can include reproduced images of an advertisement, products displayed or discussed in the advertisement or in an editorial, descriptive information about the products, identifying codes for the products, and availability of the products. Furthermore, the database can include the locations of online web sites and/or brick-and-mortar merchant locations where the product is available for purchase.

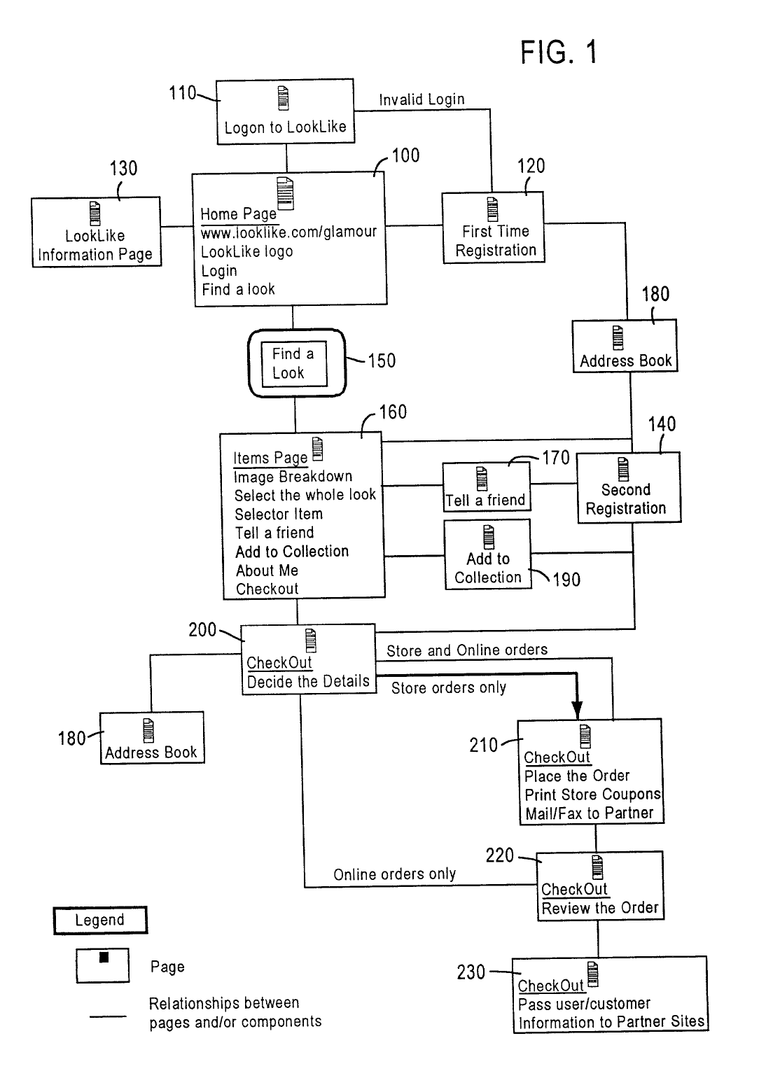

Referring to the flowchart illustrated in FIG. 1, upon entering the home page 100 of the web site, the user is prompted to enter into a login page 110. Alternatively, the home page can inquiry whether the user has a cookie that enables the user to bypass the login page. The login page asks for a user id and password, and if correctly entered, allows the user to access other pages of the web site. The user can alternatively access an information page 130 from the home page 100.

For a new user, a registration process 120 can be used to obtain information about the user in the following sections, which are discussed below: “Tell a friend”, “Enter information about me”, “Add items to the collections”, and “Checkout”. This information will be subsequently used to customize the web site to the particular user. This user information can include e-mail address, login id, gender, password, password hint question, a password hint answer, age range, and postal code. Additional user information can be obtained in a second registration page 140 and can include first name, last name, shipping and billing address, household income, work phone number and home phone number. This information can then be stored in the database.

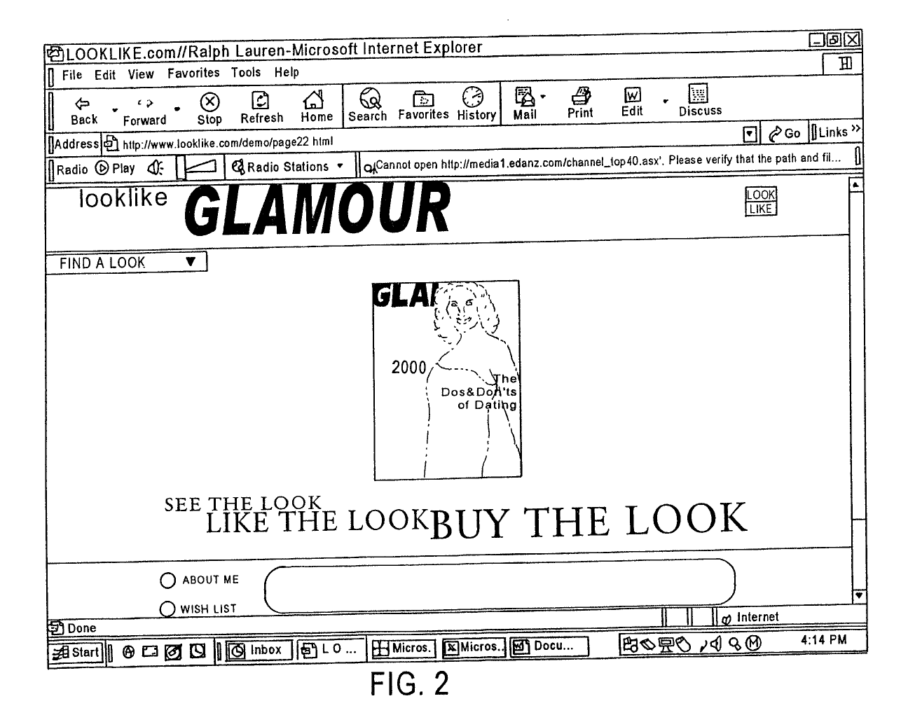

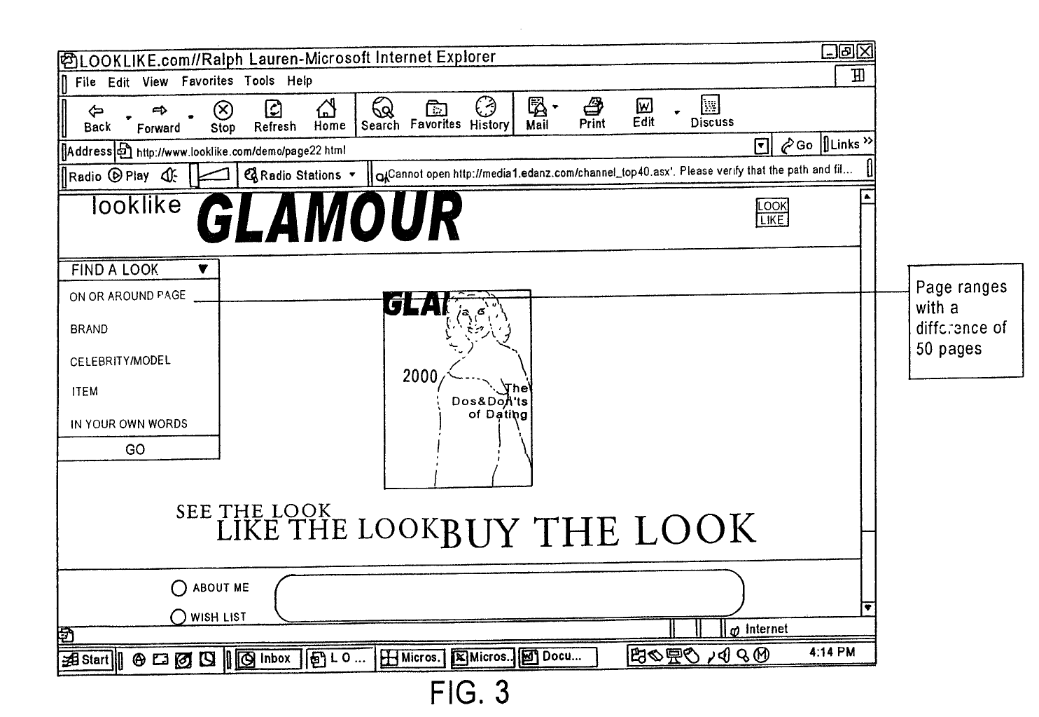

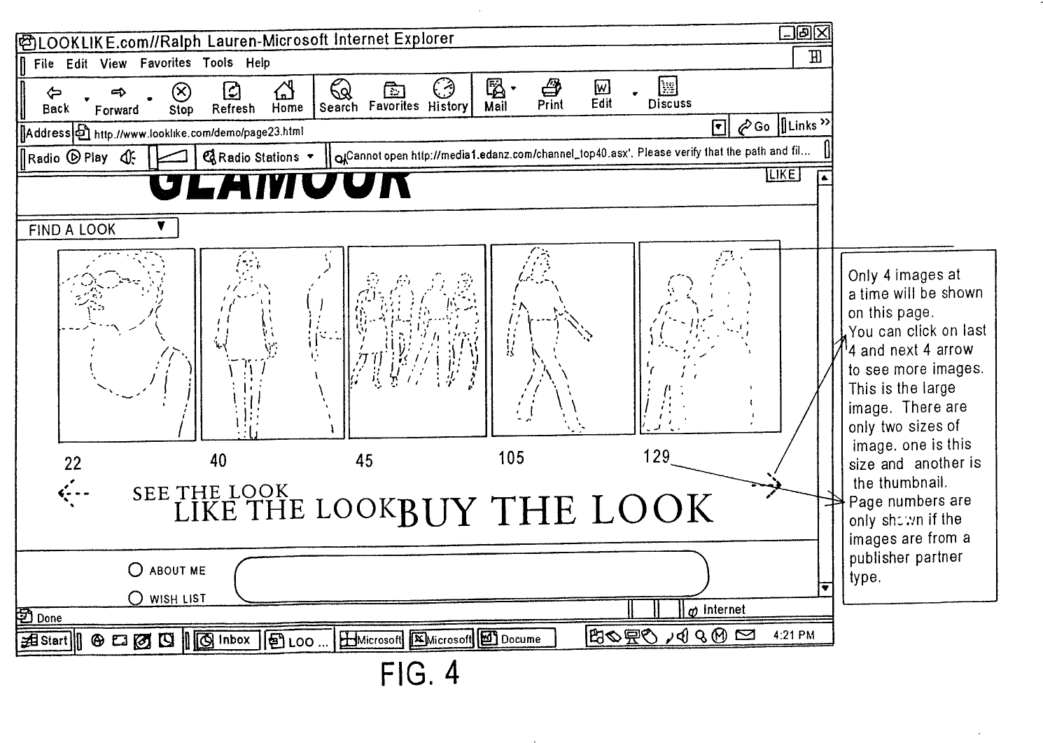

One of the features of the web site as illustrated in FIGS. 2 and 3, for illustrative purposes named “Find a Look” 150, can be incorporated into one or more drop down windows. This window can then list various search options that can be used to retrieve images from the database. Available search options can include searching by brand, advertisement or advertiser, merchant and product type. Upon retrieving the matches from the database that satisfy the criteria of the search, the corresponding images are displayed, as illustrated in FIG. 4. The page range lists can be broken into multiple page increments, for example 50 pages. Furthermore, all cover pages, which include front, back, inside front, inside back, and foldouts, can also be grouped within the page range search. In a current aspect of the invention, the images are a reproduction of the advertisement, which shows the products.

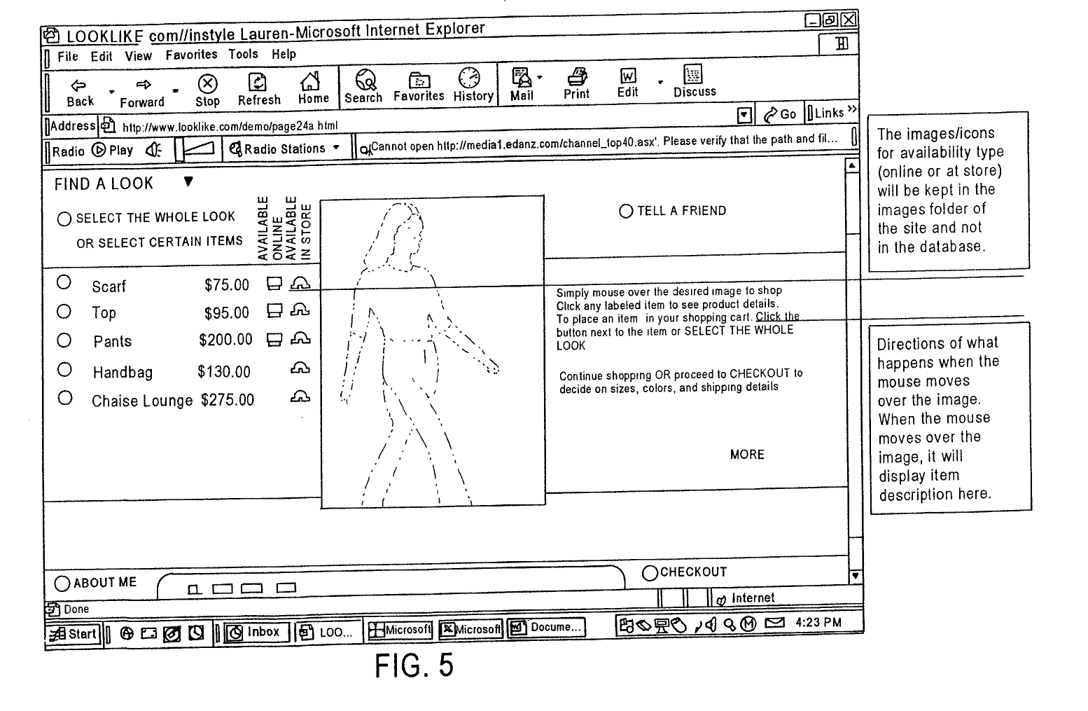

If more than four images meet the search criteria, then the images can be displayed horizontally across the center of the page. Additional images can then be retrieved by clicking on left or right arrows to display additional images. After the images have been retrieved, the user can electronically indicate a particular image, for example, by clicking on the image using a cursor. This action leads the user to a web page, for illustrative purposes named “Items Page” 160, in which the image is broken-down into constituent products along with purchase information about the products, as illustrated in FIG. 5. Purchase information can be any information that helps a user determine whether or not to purchase a product.

The image can consist of one or more components, which can each include one or more products. In a currently preferred embodiment, the image is displayed in the center of the page; the components will be listed on the left side; and a description of the components will be listed on the right side. Within the list of components, purchase information can be detailed, such as product name, price, availability online, availability at a “brick and mortar” merchant, or whether only information available only, but not the product. If information is only available, and not the product, the description area on the right side can display that relevant information. Nontraditional items, such as hotels, can also be listed as components.

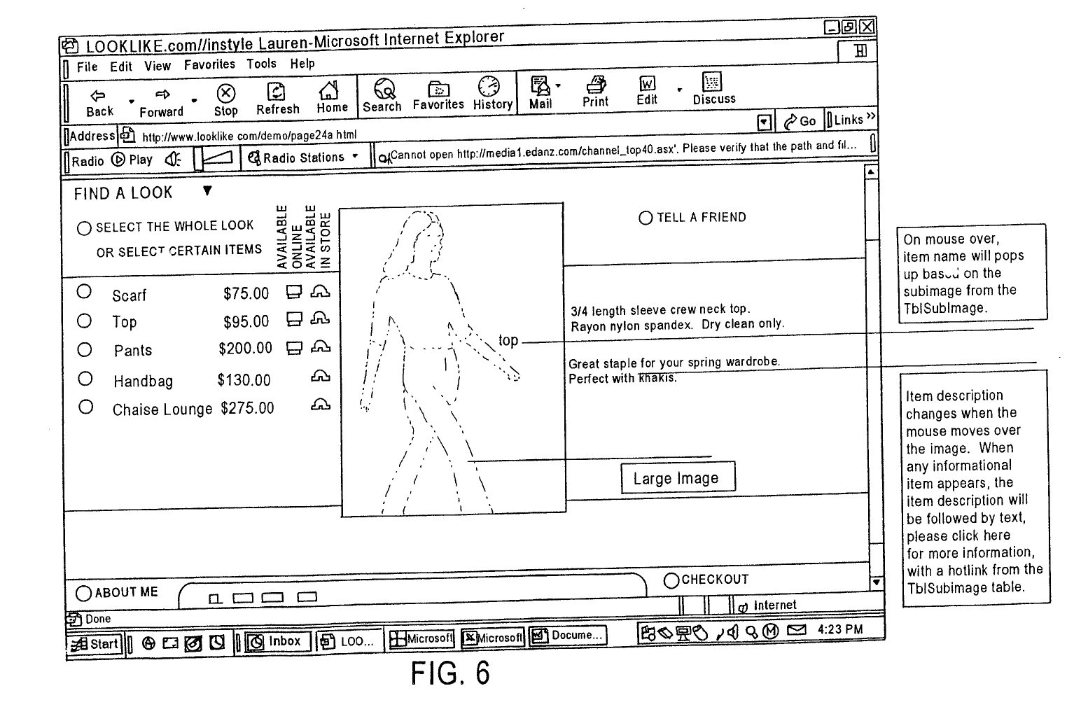

As illustrated in FIG. 6, in a current aspect of the invention, interacting with the image's components can accomplish the following: displaying the name of the component near the cursor; highlighting the corresponding product on the left side; and displaying the description of the item on the right side. Additionally, these three results can be executed dynamically as the cursor moves over the image. Depending upon how the user accesses the web site, the user interaction with the image can be by electronically indicating the product on the reproduced advertisement. This electronic indication can be by clicking on a mouse while passing an electronic cursor over an image of the product in the reproduced advertisement or by pressing a stylus against a touchpad of a personal digital assistant (PDA), which is displaying the reproduced advertisement.

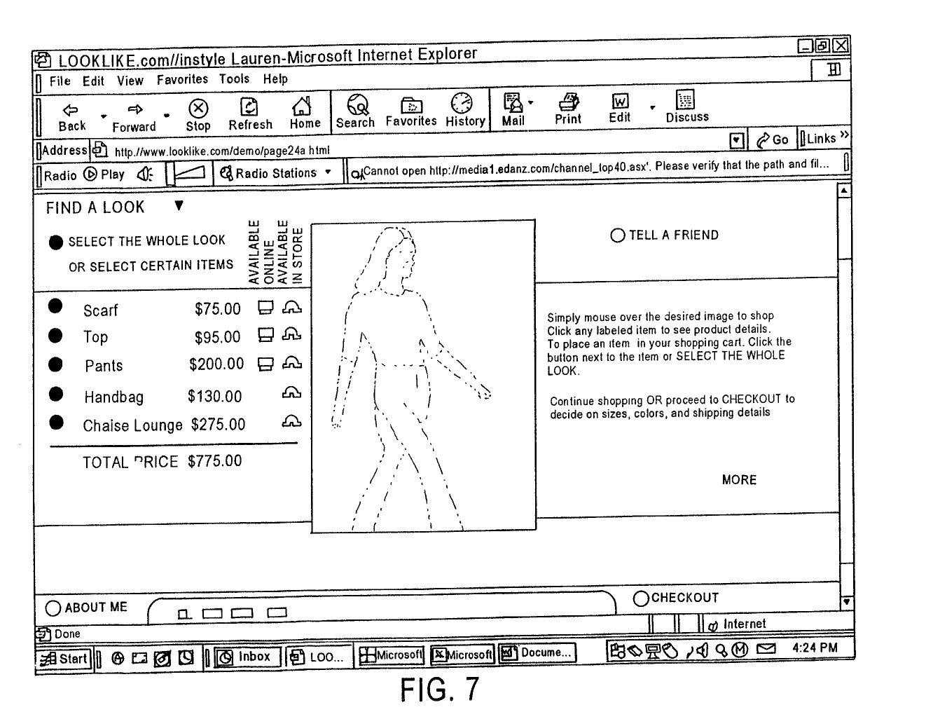

In an additional aspect of the invention, from the “Items Page” 160, a user can accomplish the following optional tasks, which are labeled for illustrative purposes: “Select the whole look”, “Select an item(s)”, “Tell a friend”, “Enter information about me”, “Add the item(s) to a collection”, “Continue shopping”, and “Checkout”. A checkbox can be associated “Select the whole look” option. Upon the user checking this box, all of the check-boxes associated with the components of the image will be automatically checked, as illustrated in FIG. 7. The user can then click on the “Add to Shopping Cart” option to add all of the items that create the look to the shopping cart. The user, however, can still have the option of unchecking any box. If the user unchecks any of the boxes, then the check box associated with “Select the whole look” will be unchecked.

Under the “Select an item(s)” option, each item or product will be associated with a separate checkbox. These separate checkboxes will allow a user to select a particular item. The user can then click on the “Add to Shopping Cart” option to add the checked items on the page to the shopping cart. Additionally, the user can also select an item by clicking when the cursor is over the image.

Using the “Tell a friend” 170 option, an e-mail of the URL for the particular page can be sent. The e-mail can also include an image of the item or product. In a current aspect of the invention, as a requisite to e-mail the page, the user's registration id and password will be required. If the user has previously registered, then the friend's e-mail address, if available, can be obtained from the address book/buddy list 180 of the user. If the user has not registered, this will prompt entry of information regarding the user. Also, if an incomplete order exists from a previous shopping experience, the user will be prompted with this information. Furthermore, the user can either continue adding to the existing cart or start a new shopping cart.

Under the “Enter Information in About Me” option, information about the user can be obtained. This information can also include an address book/buddy list 180. Also, if an incomplete order exists from a previous shopping experience, the user will be prompted with this information. Furthermore, the user can either continue adding to the existing cart or start a new shopping cart.

Under the “Add to Collection” 190, the user's registration id and password will be required in a current embodiment. If the user is unregistered, the user will be prompted to add information using the “Enter information about me” option. Upon the entering of the user's registration id and password, those items currently selected on the page will be added to a collection. This collection can be used in the database for future access by the user.

Under the “Continue Shopping” option, the user can continue with any of the above described-processes. If there are any items in the shopping cart, the user can proceed to the “Checkout” 200 option. In a present embodiment of the invention, the user's registration id and password will be required before the user can proceed with the checkout process. If it's an unregistered user then the second registration process 140 will be executed. Also, if an incomplete order exists from a previous shopping experience, the user will be prompted with this information. Furthermore, the user can either continue adding to the existing cart or start a new shopping cart.

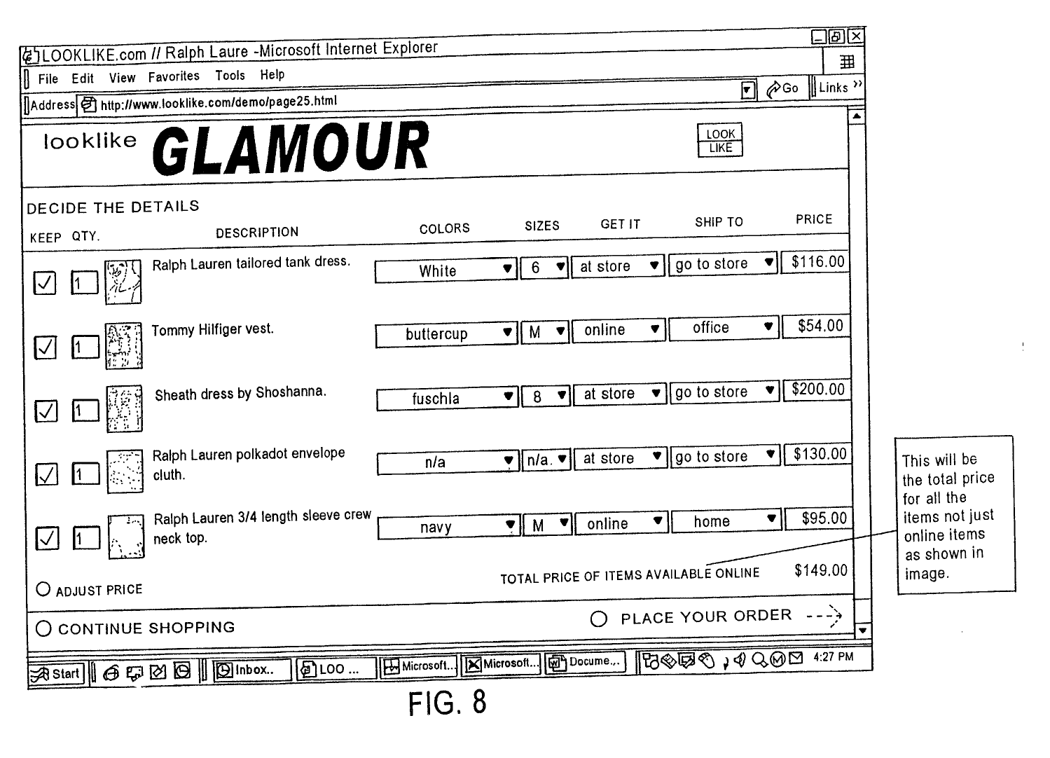

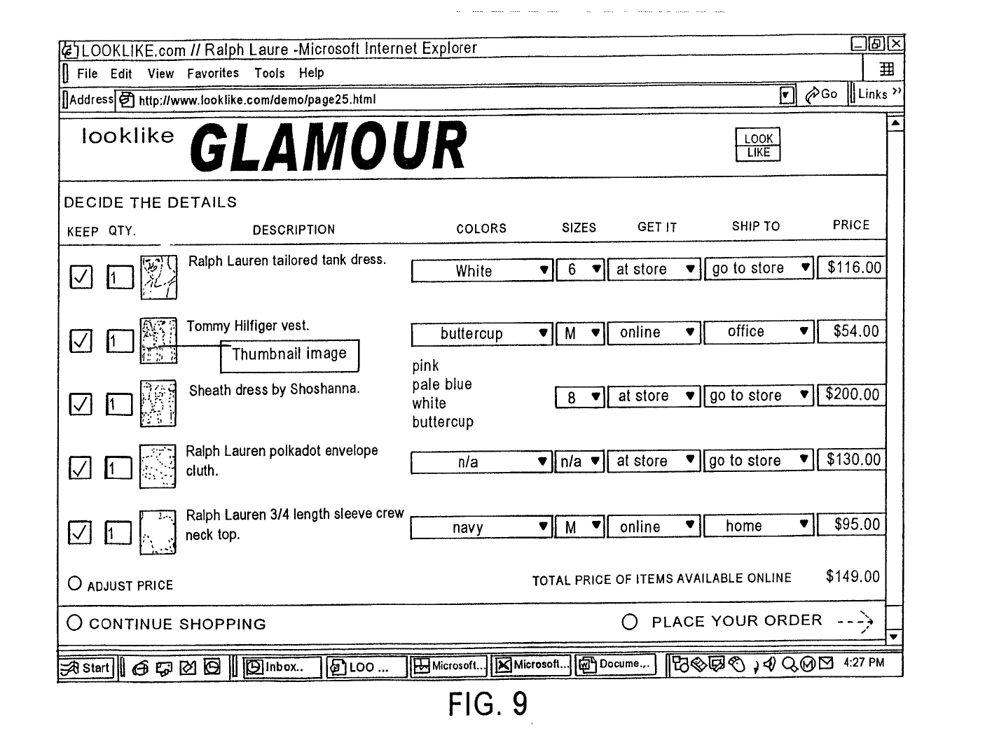

In a current aspect of the invention, the “Checkout” 200 option is a two-step process, which are labeled for illustrative purposes: “Decide the details” 200 and “Place the order” 210. Under the “Decide the details” 200 step, all items in the shopping cart are displayed on the page, as illustrated in FIGS. 8 and 9. Additionally, a checkbox can be placed adjacent each item with the checkbox being used to indicate whether a particular item is to be kept. This step can also involves displaying a thumbnail size picture of the item; a brief description of the item; the number of items to be purchased; available choices for a particular item, such as color and size; the location at which the item can be obtained, such as an online store or a bricks and mortar merchant.

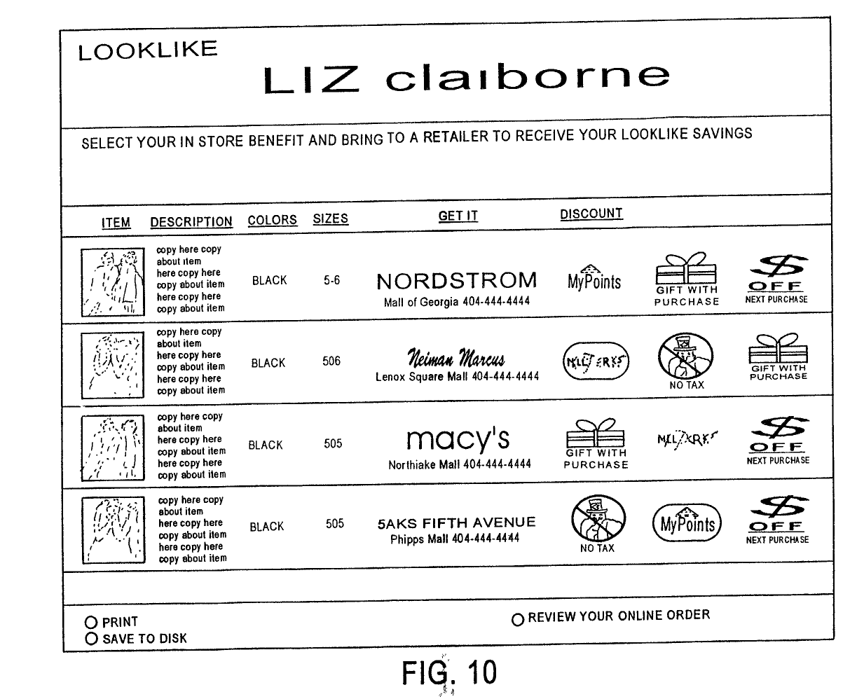

If the user selects a bricks and mortar merchant, the name, address, and telephone number of the merchant will be displayed. Additionally, if more than one merchant has the item available, a list of the merchants can be displayed, as illustrated in FIG. 10. Alternatively, one merchant of many merchants carrying the item can be selected based on proximity to a user-defined preferred location. The merchant can also be selected from a user-defined list of preferred merchants. When a merchant is displayed, an order can additionally be displayed which includes an item code; a thumbnail size picture of the item; a brief description of the item; the number of items to be purchased; the choices available for the item; the merchant's address, and any discount available from the merchant. This list can then be printed by the user to be used to help the user make the actual purchase at a particular merchant. Additionally, the list can also be transmitted, for example by facsimile or e-mail, to the merchant to prepare the merchant for a potential customer.

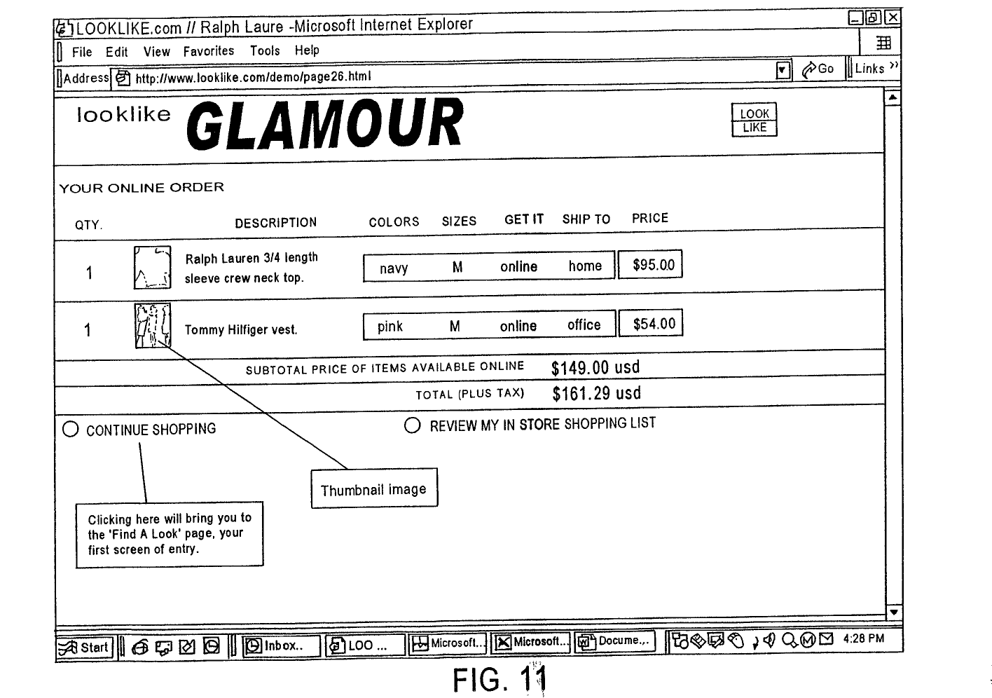

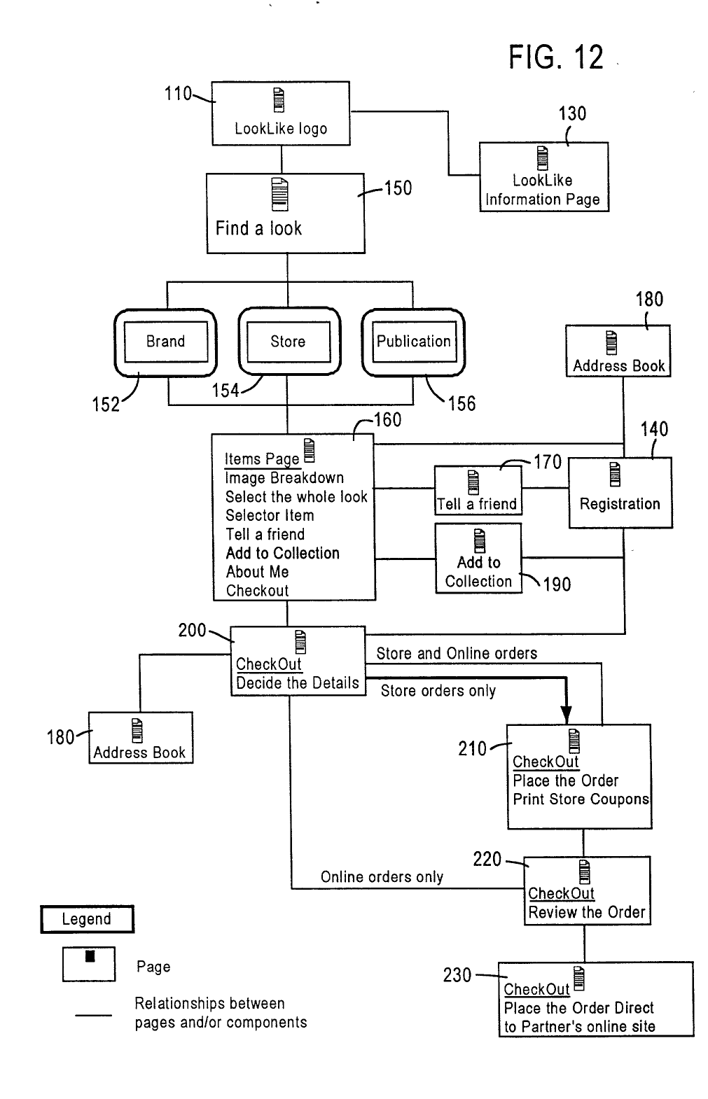

Under the “Place the order” 210 step, the order can be directed to either an online merchant or a bricks and mortar merchant. If the user has selected both placing the order with an online merchant and with a bricks and mortar merchant, the bricks and mortar merchants will be executed and then the online order. If the purchase is with an online merchant, the user will then be directed to the brand or merchant's online transaction site. Before the redirection takes place, however, the user's online order will again be displayed for review 220, as illustrated in FIG. 11. At this time, the user will have the option of amending the order by adding, deleting or modifying a selected item. The user can also be given the option to continue or abandon shopping.

Upon deciding to continue shopping, the user's payment information can then be passed to the brand or merchant's web site in addition to the order details and user information 230. If the user has selected more than one online merchant or brand, the user's information will be passed to all of the merchants and/or brands. In a preferred embodiment, the brand or merchant can obtain additional information from the user such as credit card number, shipping information, and/or billing information.

If the user abandons the process, the shopping cart information can be stored in the database. Furthermore, the next time the user visits the site, the user can be prompted with the already existing shopping cart and queried whether the user would like to continue with the old cart or start shopping with a new cart.

### EXAMPLE 2

In another example, applicable to product brands and stores, the web site is embedded within the brand or store web site. For example, when a user is in the brand or store web site, by clicking on a specific icon or logo 110, the user will be transferred into the web site, which will preferably include a look and feel that is similar to that of the web site of the brand of store. Additionally, the navigation bar of the brand or store web site can be visible at all times. The user can alternatively access an information page 130 from the logo 110.

The database, which is accessible by the web site, can include reproduced images of an advertisement, products displayed or discussed in the advertisement or in an editorial, descriptive information about the products, identifying codes for the products, and availability of the products. Furthermore, the database can include the locations of online web sites and/or brick-and-mortar merchant locations where the product is available for purchase.

As the user has entered the web site via a partner site, registration information may be retrieved from the partner site. However, if some or all of the user information is not available from the partner site, the user will be prompted at a point to perform a registration process 140. This registration process 140 can be used to obtain information about the user in the following sections, which are discussed below: “Tell a friend”, “Enter information about me”, “Add items to the collections”, and “Checkout”. This information will be subsequently used to customize the web site to the particular user. This user information can include e-mail address, login id, gender, password, password hint question, a password hint answer, age range, and postal code. Additional user information can be obtained in a second registration page 140 and can include first name, last name, shipping and billing address, household income, work phone number and home phone number. This information can then be stored in the database.

One of the features of the web site, for illustrative purposes named “Find a Look” 150, can be incorporated into one or more drop down windows. This window can then list various search options that can be used to retrieve images from the database. Available search options can include searching by brand 152, merchant 154 or publication 156. The search options for a brand 152 can include gender, item and/or magazine in which the user viewed the advertisement. The search options for a merchant 154 can include brand, gender, item, price range, merchant-specified category and any combination of these options can be selected. The search options for a publication 156 can include merchant, brand, gender, item, and any one, two, three or four options can be selected. To facilitate the searching, there can be separate drop downs for brand, gender and item. In a current aspect of the invention, the images are a reproduction of the advertisement, which shows the products.

If more than four images meet the search criteria, then the images can be displayed horizontally across the center of the page. Additional images can then be retrieved by clicking on left or right arrows to display additional images. After the images have been retrieved, the user can electronically indicate a particular image, for example, by clicking on the image using a cursor. This action leads the user to a web page, for illustrative purposes named “Items Page” 160, in which the image is broken-down into constituent products along with purchase information about the products. Purchase information can be any information that helps a user determine whether or not to purchase a product.

The image can consist of one or more components, which can each include one or more products. In a currently preferred embodiment, the image is displayed in the center of the page; the components will be listed on the left side; and a description of the components will be listed on the right side. Within the list of components, purchase information can be detailed, such as product name, price, availability online, availability at a “brick and mortar” merchant, or whether only information available only, but not the product. If information is only available, and not the product, the description area on the right side can display that relevant information. Nontraditional items, such as hotels, can also be listed as components.

In a current aspect of the invention, interacting with the image's components can accomplish the following: displaying the name of the component near the cursor; highlighting the corresponding product on the left side; and displaying the description of the item on the right side. Additionally, these three results can be executed dynamically as the cursor moves over the image. Depending upon how the user accesses the web site, the user interaction with the image can be by electronically indicating the product on the reproduced advertisement. This electronic indication can be by clicking on a mouse while passing an electronic cursor over an image of the product in the reproduced advertisement or by pressing a stylus against a touchpad of a personal digital assistant (PDA), which is displaying the reproduced advertisement.

In an additional aspect of the invention, from the “Items Page” 160, a user can accomplish the following optional tasks, which are labeled for illustrative purposes: “Select the whole look”, “Select an item(s)”, “Tell a friend”, “Enter information about me”, “Add the item(s) to a collection”, “Continue shopping”, and “Checkout”. A checkbox can be associated “Select the whole look” option. Upon the user checking this box, all of the check-boxes associated with the components of the image will be automatically checked. The user can then click on the “Add to Shopping Cart” option to add all of the items that create the look to the shopping cart. The user, however, can still have the option of unchecking any box. If the user unchecks any of the boxes, then the check box associated with “Select the whole look” will be unchecked.

Under the “Select an item(s)” option, each item or product will be associated with a separate checkbox. These separate checkboxes will allow a user to select a particular item. The user can then click on the “Add to Shopping Cart” option to add the checked items on the page to the shopping cart. Additionally, the user can also select an item by clicking when the cursor is over the image.

Using the “Tell a friend” 170 option, an e-mail of the URL for the particular page can be sent. The e-mail can also include an image of the item or product. In a current aspect of the invention, as a requisite to e-mail the page, the user's registration id and password will be required. If the user has previously registered, then the friend's e-mail address, if available, can be obtained from the address book/buddy list 180 of the user. If the user has not registered, this will prompt entry of information regarding the user. Also, if an incomplete order exists from a previous shopping experience, the user will be prompted with this information. Furthermore, the user can either continue adding to the existing cart or start a new shopping cart.

Under the “Enter Information in About Me” option, information about the user can be obtained. This information can also include an address book/buddy list 180. Also, if an incomplete order exists from a previous shopping experience, the user will be prompted with this information. Furthermore, the user can either continue adding to the existing cart or start a new shopping cart.

Under the “Add to Collection” 190, the user's registration id and password will be required in a current embodiment. If the user is unregistered, the user will be prompted to add information using the “Enter information about me” option. Upon the entering of the user's registration id and password, those items currently selected on the page will be added to a collection. This collection can be used in the database for future access by the user.

Under the “Continue Shopping” option, the user can continue with any of the above described-processes. If there are any items in the shopping cart, the user can proceed to the “Checkout” 200 option. In a present embodiment of the invention, the user's registration id and password will be required before the user can proceed with the checkout process. If it's an unregistered user then the second registration process 140 will be executed. Also, if an incomplete order exists from a previous shopping experience, the user will be prompted with this information. Furthermore, the user can either continue adding to the existing cart or start a new shopping cart.

In a current aspect of the invention, the “Checkout” 200 option is a two-step process, which are labeled for illustrative purposes: “Decide the details” 200 and “Place the order” 210. Under the “Decide the details” 200 step, all items in the shopping cart are displayed on the page. Additionally, a checkbox can be placed adjacent each item with the checkbox being used to indicate whether a particular item is to be kept. This step can also involves displaying a thumbnail size picture of the item; a brief description of the item; the number of items to be purchased; available choices for a particular item, such as color and size; the location at which the item can be obtained, such as an online store or a bricks and mortar merchant.

If the user selects a bricks and mortar merchant, the name, address, and telephone number of the merchant will be displayed. Additionally, if more than one merchant has the item available, a list of the merchants can be displayed. Alternatively, one merchant of many merchants carrying the item can be selected based on proximity to a user-defined preferred location. The merchant can also be selected from a user-defined list of preferred merchants. When a merchant is displayed, an order can additionally be displayed which includes an item code; a thumbnail size picture of the item; a brief description of the item; the number of items to be purchased; the choices available for the item; the merchant's address, and any discount available from the merchant. This list can then be printed by the user to be used to help the user make the actual purchase at a particular merchant. Additionally, the list can also be transmitted, for example by facsimile or e-mail, to the merchant to prepare the merchant for a potential customer.

Under the “Place the order” 210 step, the order can be directed to either an online merchant or a bricks and mortar merchant. If the user has selected both placing the order with an online merchant and with a bricks and mortar merchant, the bricks and mortar merchants will be executed and then the online order. If the purchase is with an online merchant, the user will then be directed to the brand or merchant's online transaction site. Before the redirection takes place, however, the user's online order will again be displayed for review 220. At this time, the user will have the option of amending the order by adding, deleting or modifying a selected item. The user can also be given the option to continue or abandon shopping.

Upon deciding to continue shopping, the user's payment information can then be passed to the brand or merchant's web site in addition to the order details and user information 230. If the user has selected more than one online merchant or brand, the user's information will be passed to all of the merchants and/or brands. In a preferred embodiment, the brand or merchant can obtain additional information from the user such as credit card number, shipping information, and/or billing information.

If the user abandons the process, the shopping cart information can be stored in the database. Furthermore, the next time the user visits the site, the user can be prompted with the already existing shopping cart and queried whether the user would like to continue with the old cart or start shopping with a new cart.

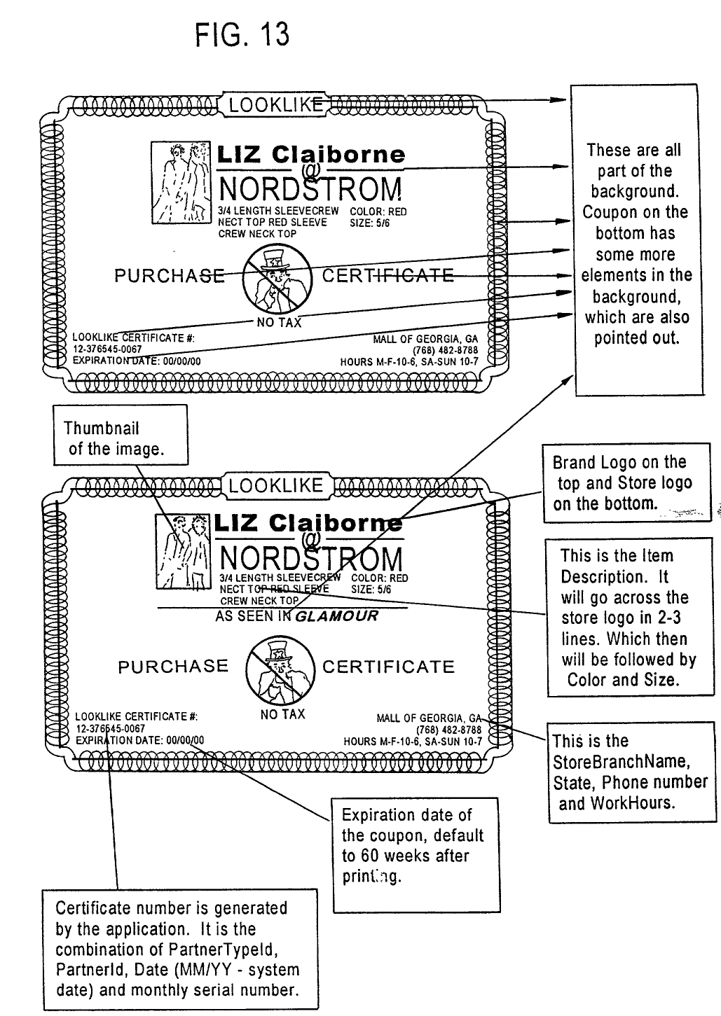

In an additional aspect of the invention, as illustrated in FIG. 13, a “Refer-to-Store Certificate” (or coupon) can be provided to the customer for a particular product. This coupon can therefore provide further incentive the customer to purchase the product. This coupon can be individualized for a particular product, brand, merchant, and/or user and include such information as a description of the product, price of the product. The coupon can then be delivered to the user via facsimile or an internet-enabled device. Alternatively, the coupon can be delivered to a particular merchant selling the product.

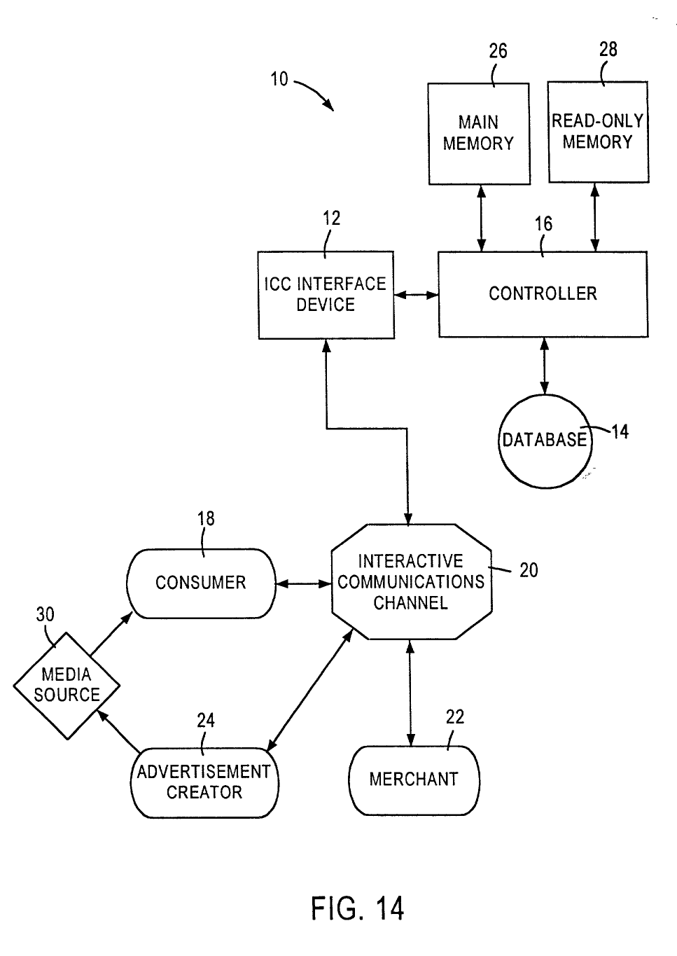

Various embodiments of the present invention may be implemented on a computer. FIG. 14 is a block diagram that illustrates a computer system 10 upon which an embodiment of the invention may be implemented. The computer system 10 includes a interactive communications channel (ICC) interface device 12 or other communication mechanism for communicating information, and a controller 16 coupled with the ICC interface device 12 for processing information, such as determining which information is provided to a user 18 based upon data received from the user 18. The computer system 10 also includes a main memory 26, such as a random access memory (RAM) or other dynamic storage device, coupled to the ICC interface device 12 for storing information and instructions to be executed by the controller 16. The main memory 26 also may be used for storing temporary variables or other intermediate information during execution of instructions to be executed by the controller 16. The computer system 10 further includes a read only memory (ROM) 28 or other static storage device coupled to ICC interface device 12 for storing static information and instructions for controller 16. A storage device (or database) 14, such as a magnetic disk or optical disk, is provided and coupled to the controller 16 for storing information and instructions.

The invention is related to the use of computer system 10 for providing purchase information to a user about a product. According to one embodiment of the invention, the information is provided by the computer system 10 in response to the controller 16 executing one or more sequences of one or more instructions contained in the main memory 26. Such instructions may be read into the main memory 26 from another computer-readable medium, such as the storage device 14. Execution of the sequences of instructions contained in the main memory 26 causes the controller 16 to perform the process steps previously described herein. One or more processors in a multi-processing arrangement may also be employed to execute the sequences of instructions contained in the main memory 26. In alternative embodiments, hardwired circuitry may be used in place of or in combination with software instructions to implement the invention. Thus, embodiments of the invention are not limited to any specific combination of hardware circuitry and software.

The term “computer-readable medium”, as used herein, refers to any medium that participates in providing instructions to the controller 16 for execution. Such a medium may take many forms, including but not limited to non-volatile media, volatile media, and transmission media. Non-volatile media include, for example, optical or magnetic disks, such as the storage device 14. Volatile media include dynamic memory, such as the main memory 26. Transmission media include coaxial cables, copper wire and fiber optics, including the wires that comprise ICC interface device 12. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the controller 16 for execution. For example, the instructions may initially be borne on a magnetic disk of a remote computer. The remote computer can load the instructions into its dynamic memory and send the instructions over a telephone line using a modem. A modem local to the computer system 10 can receive the data on the telephone line and use an infrared transmitter to convert the data to an infrared signal. An infrared detector coupled to the ICC interface device 12 can receive the data carried in the infrared signal and place the data on the ICC interface device 12. The ICC interface device 12 carries the data to the main memory 26, from which the controller 16 retrieves and executes the instructions. The instructions received by the main memory 26 may optionally be stored on the storage device 14 either before or after execution by the controller 16.

As defined, the ICC interface device 12 can be connected to or include an interactive communications channel 20. The interactive communications channel 20 is an interactive link between the user 18 and the system 10 that enables the user 18 to selectively retrieve information about products stored in the database 14. The interactive communications channel 20 can also include a link to a merchant 22 of the product. Using this link, the merchant 22 can update or supply information about the product to the system 10. This information can be stored in the database 14 or transmitted directly to the user 18.

An example of an interactive communications channel 20 is a network link connected to a local network. The ICC interface device 12, for example can be an integrated services digital network (ISDN) card or a modem to provide a data communication connection to a corresponding type of telephone line. As another example, the ICC interface device 12 can be a local area network (LAN) card to provide a data communication connection to a compatible LAN. Wireless links may also be implemented. In any such implementation, the ICC interface device 12 sends and receives electrical, electromagnetic or optical signals that carry digital data streams representing various types of information.

Additionally, a link can be provided between a creator 24 of an advertisement for the product and the system 10. In an aspect of the invention, the advertisement showing the product is reproduced in the database 14. This reproduced advertisement can then be accessed by the user 18. The user 18, upon finding a particular product in an advertisement, can obtain additional information about the product from the database 14. By linking to the creator 24 of the advertisement, the system 10 can be supplied with advertisements for entry into the database 14. Additionally, the creator 24 can provide the system about additional information about products in the advertisement such as the type, merchant (or brand), description, and price.

The computer system 10 can send messages and receive data, including program code, through the interactive communications channel 20. In an internet example, a server might transmit a code through the internet, ISP, local network and ICC interface device 12. In accordance with the invention, the received code may be executed by controller 16 as it is received, and/or stored in storage device 14, or other non-volatile storage for later execution. This code can then be used by the computer system 10 to execute a method of providing information to a user as previously described herein.

In one aspect of the invention, the code is an electronically recognizable identifier associated with the media source 30 and/or advertisement within the media source 30. This electronically recognizable identifier can advantageously provide quicker access to the web page that shows the reproduced image of the advertisement. In this manner, the user 18 can bypass layers in the web site the user 18 would normally have to access before accessing the reproduced image of the advertisement. Any electronically recognizable identifier is acceptable for use with the invention, and examples include a bar code and a digital signal. The digital signal, for example, can be embedded within the media source 30 or within the advertisement.

The present invention can be practiced by employing conventional methodology and equipment. Accordingly, the details of such equipment and methodology are not set forth herein in detail. In the previous descriptions, numerous specific details are set forth in order to provide a thorough understanding of the present invention. However, it should be recognized that the present invention can be practiced without resorting to the details specifically set forth. In other instances, well known processing structures or methods have not been described in detail, in order not to unnecessarily obscure the present invention.

Only the preferred embodiment of the present invention and but a few examples of its versatility are shown and described in the present disclosure. It is to be understood that the present invention is capable of use in various other combinations and environments and is capable of changes or modifications within the scope of the inventive concept as expressed herein.

What is claimed is:

1. A method for providing information about a product, comprising the steps of:
identifying at least one product in an advertisement in a first media source;
obtaining the information about the product;
sorting the product in a database by the information obtained;
reproducing the advertisement in an interactive media source;
associating the information about the product with the reproduced advertisement in the interactive media source; and
providing the information about the product when a user interacts with the reproduced advertisement.

2. The method for providing information about a product according to claim 1, wherein the user interaction involves electronically indicating one of the at least one product on the reproduced advertisement.

3. The method for providing information about the product according to claim 2, wherein the electronic indication is passing an electronic cursor over an image of the product in the reproduced advertisement.

4. The method for providing information about the product according to claim 2, wherein the electronic indication is pressing a stylus against a touchpad of a personal digital assistant (PDA) associated with an image of the product in the reproduced advertisement.

5. The method for providing information about a product according to claim 1, wherein the at least one product in the advertisement is identified by a creator of the advertisement.

6. The method for providing information about a product according to claim 1, wherein the product is selected from one of goods and services.

7. The method for providing information about the product according to claim 1, wherein the first media source is print media.

8. The method for providing information about the product according to claim 7, wherein the advertisement is a print advertisement.

9. The method for providing information about the product according to claim 1, wherein the first media source is in the form of video.

10. The method for providing information about the product according to claim 9, wherein the advertisement is a commercial.

11. The method for providing information about the product according to claim 1, wherein purchase information is provided about the product.

12. The method for providing information about the product according to claim 11, wherein the purchase information includes a location of a merchant selling the product.

13. The method for providing information about the product according to claim 12, wherein the merchant selling the product is selected by determining a merchant having a closest location to a user preferred location.

14. The method for providing information about the product according to claim 12, wherein the merchant is further determined by selecting the merchant from a list of user-preferred types of merchants.

15. The method for providing information about the product according to claim 11, wherein the purchase information includes at least one of an image of the product, a description of the product, a price of the product, and an availability of the product.

16. The method for providing information about the product according to claim 11, wherein the purchase information includes a coupon for the product.

17. The method for providing information about the product according to claim 16, further comprising the step of delivering the coupon to the user via facsimile.

18. The method for providing information about the product according to claim 16, further comprising the step of delivering the coupon to the user via an internet-enabled device.

19. The method for providing information about the product according to claim 18, wherein the internet-enabled device is selected from one of a computer, a phone, and a personal digital assistant (PDA).

20. The method for providing information about the product according to claim 16, further comprising the step of delivering the coupon to a merchant selling the product.

21. The method for providing information about the product according to claim 1, wherein the product is located on the interactive media source by searching according to a brand of the product.

22. The method for providing information about the product according to claim 1, wherein the product is located on the interactive media source by searching according to the first media source.

23. The method for providing information about the product according to claim 1, wherein the product is located on the interactive media source by searching according to a product type.

24. The method for providing information about the product according to claim 1, wherein the product is located on the interactive media source by searching according to a merchant.

25. The method for providing information about the product according to claim 1, wherein the product is located on the interactive media source by searching according to the advertisement.

26. The method for providing information about the product according to claim 1, wherein the information is obtained through an interactive communications channel.

27. The method for providing information about the product according to claim 26, wherein the interactive communications channel is accessed via an internet-enabled device.

28. The method for providing information about the product according to claim 27, wherein the internet-enabled device is selected from one of a computer, a phone, and a personal digital assistant (PDA).

29. The method for providing information about the product according to claim 1, wherein the interactive media source is selected from one of an internet, a network, and a cable system.

30. The method for providing information about the product according to claim 1, wherein the location on the interactive media source of the information is obtained using an electronically-recognizable identifier associated with the first media source.

31. The method for providing information about the product according to claim 30, wherein the identifier is associated with the advertisement.

32. The method for providing information about the product according to claim 30, wherein the identifier is a barcode.

33. The method for providing information about the product according to claim 30, wherein the identifier is a digital signal.

34. A method for providing purchase information about a product, comprising the steps of:
identifying at least one product in a print advertisement in a print media source, the product being identified by a creator of the print advertisement;
obtaining the purchase information about the product;
sorting the product in a database by the purchase information obtained;
reproducing the print advertisement in an interactive media source;
associating the information about the product to the reproduced advertisement in the interactive media source; and
providing the information about the product when a user interacts with the reproduced advertisement by electronically indicating one of the at least one product on the reproduced print advertisement using an interactive communications channel.

35. A data signal in a carrier wave for providing information to a user about a product in an advertisement displayed in a first media source, the data signal in a carrier wave comprising:
electronic indication signals, the electronic indication signals being received by an interactive communications channel interface device from the user and the electronic indication signals in reference to a reproduction of the advertisement displayed in an interactive media source; and
product information signals, the product information signals being output by the interactive communications channel interface device and the product information signals being determined by a controller based upon the electronic indication signals received from the user.

36. The data signal in a carrier wave according to claim 35, wherein the electronic indication signals are generated by passing an electronic cursor over an image of the product in the reproduced advertisement.

37. The data signal in a carrier wave according to claim 35, wherein the electronic indication signals are generated by pressing a stylus of against a touchpad of a personal digital assistant (PDA) associated with an image of the product in the reproduced advertisement.

38. The data in a carrier wave according to claim 35, wherein the product is selected from one of goods and services.

39. The data signal in a carrier wave according to claim 35, wherein the first media source is print media.

40. The data signal in a carrier wave according to claim 39, wherein the advertisement is a print advertisement.

41. The data signal in a carrier wave according to claim 35, wherein the first media source is in the form of video.

42. The data signal in a carrier wave according to claim 41, wherein the advertisement is a commercial.

43. The data signal in a carrier wave according to claim 35, wherein the product information signals include purchase information about the product.

44. The data signal in a carrier wave according to claim 43, wherein the purchase information includes a location of a merchant selling the product.

45. The data signal in a carrier wave according to claim 44, wherein the merchant selling the product is selected by determining a merchant having a closest location to a user-preferred location.

46. The data signal in a carrier wave according to claim 45, wherein the merchant is further selected from a list of user-preferred type of merchants.

47. The data signal in a carrier wave according to claim 43, wherein the purchase information includes at least one of an image of the product, a description of the product, a price of the product, and an availability of the product.

48. The data signal in a carrier wave according to claim 43, wherein the purchase information includes a coupon for the product.

49. The data signal in a carrier wave according to claim 48, wherein the coupon is delivered to a merchant selling the product.

50. The data signal in a carrier wave according to claim 35, wherein the product information signals are delivered to the user via facsimile.

51. The data signal in a carrier wave according to claim 35, wherein the product information signals are delivered to the user via an internet-enabled device.

52. The data signal in a carrier wave according to claim 51, wherein the internet-enabled device is selected from one of a computer, a phone, and a personal digital assistant (PDA).

53. The data signal in a carrier wave according to claim 35, wherein the product is located on the interactive media source by the user searching according to a brand of the product.

54. The data signal in a carrier wave according to claim 35, wherein the product is located on the interactive media source by the user searching according to the first media source.

55. The data signal in a carrier wave according to claim 35, wherein the product is located on the interactive media source by the user searching according to a product type.

56. The data signal in a carrier wave according to claim 35, wherein the product is located on the interactive media source by the user searching according to a merchant.

57. The data signal in a carrier wave according to claim 35, wherein the product is located on the interactive media source by the user searching according to the advertisement.

58. The data signal in a carrier wave according to claim 35, wherein the interactive communications channel interface device is connected to a interactive communications channel.

59. The data signal in a carrier wave according to claim 35, wherein the interactive communications channel is accessed by the user via an internet-enabled device.

60. The data signal in a carrier wave according to claim 59, wherein the internet-enabled device is selected from one of a computer, a phone, and a personal digital assistant (PDA).

61. The data signal in a carrier wave according to claim 35, wherein the interactive media source is selected from one of an internet, a network, and a cable system.

62. The data signal in a carrier wave according to claim 35, wherein the electronic indication signals include an identifier.

63. The data signal in a carrier wave according to claim 35, wherein the identifier is a digital signal.

64. A data signal in a carrier wave for providing information to a user about a product in an advertisement displayed in a print media source, the data signal in a carrier wave comprising:
electronic indication signals, the electronic indication signals being received by an interactive communications channel interface device from the user via an interactive communications channel and the electronic indication signals in reference to a reproduction of the advertisement displayed in an interactive media source; and
product purchase information signals, the product purchase information signals being output by the interactive communications channel interface device and the product information signals being determined by a controller based upon the electronic indication signals received from the user.

65. A computer-implemented system for providing information about a product displayed in an advertisement in a first media source, the system comprising:
an interactive communications channel interface device for receiving data from the user and for providing the information about the product to the user, the user data including electronic indications about the product in reference to a reproduction of the advertisement;
a data storage device for storing the data received from the interactive communications channel and for storing the reproduction of the advertisement and information about the product, the information about the product being associated with the reproduction of the advertisement; and
a controller for determining the information to be provided to the user based on the data received from the user.

66. The system for providing information about the product according to claim 65, wherein the interactive communications channel interface device includes an electronic cursor for indicating the product.

67. The system for providing information about the product according to claim 65, wherein the interactive communications channel interface device is connected to one of an internet, a network, and a cable system.

68. The system for providing information about a product according to claim 65, wherein the interactive communications channel interface device is connected to a creator of the advertisement for obtaining identities of products displayed in the advertisement.

69. The system for providing information about the product according to claim 65, wherein the interactive communications channel interface device is connected to a merchant of the product for supplying purchase information about the product.

70. The system for providing information about the product according to claim 69, wherein the purchase information includes a location of a particular merchant selling the product.

71. The system for providing information about the product according to claim 70, wherein the controller selects the particular merchant by determining the particular merchant having a closest location to a user-preferred location.

72. The system for providing information about the product according to claim 70, wherein the controller further determines the particular the merchant by selecting the merchant from a list of user-preferred type of merchants.

73. The system for providing information about the product according to claim 69, wherein the purchase information includes at least one of an image of the product, a description of the product, a price of the product, and an availability of the product.

74. The system for providing information about the product according to claim 65, wherein the information provided to the customer includes a coupon for the product.

75. The system for providing information about the product according to claim 74, wherein the interactive communications channel interface device is connected to an internet-enabled device to provide the coupon to the user.

76. The system for providing information about the product according to claim 75, wherein the internet-enabled device is selected from one of a computer, a phone, and a personal digital assistant (PDA).

77. The system for providing information about the product according to claim 74, wherein the interactive communications channel interface device is connected to a merchant selling the product for delivering the coupon to the merchant.

78. The system for providing information about the product according to claim 65, wherein the controller searches the data storage base for the product according to a brand of the product.

79. The system for providing information about the product according to claim 65, wherein the controller searches the data storage base for the product according to the first media source.

80. The system for providing information about the product according to claim 65, wherein the controller searches the data storage base for the product according to a product type.

81. The system for providing information about the product according to claim 65, wherein the controller searches the data storage base for the product according to a merchant.

82. The system for providing information about the product according to claim 65, wherein the controller searches the data storage base for the product according to the advertisement.

83. The system for providing information about the product according to claim 65, wherein the user accesses the interactive communications channel interface device via an internet-enabled device.

84. The system for providing information about the product according to claim 83, wherein the internet-enabled device is selected from one of a computer, a phone, and a personal digital assistant (PDA).

85. The system for providing information about the product according to claim 65, wherein the controller locates the information about the product in the data storage device using an electronically-recognizable identifier associated with the first media source.

86. The system for providing information about the product according to claim 85, wherein the identifier is associated with the advertisement.

87. The system for providing information about the product according to claim 86, wherein the identifier is a barcode.

88. The system for providing information about the product according to claim 86, wherein the identifier is a digital signal.
associating the information about the product to the reproduced advertisement in the interactive media source; and
providing the information about the product when a user interacts with the reproduced advertisement.

91. A computer readable medium bearing instructions for providing information about a product, said instructions being arranged to cause one or more processors upon execution thereof to perform the steps of:
identifying at least one product in a print advertisement in a print media source from a creator of the print advertisement;
obtaining the purchase information about the product;
sorting the product in a database by the purchase information obtained;
reproducing the print advertisement in an interactive media source;
associating the information about the product to the reproduced advertisement in the interactive media source; and
providing the information about the product when a user interacts with the reproduced advertisement by electronically indicating one of the at least one product on the reproduced print advertisement using an interactive communications channel.

92. A computer readable medium bearing instructions for providing information about a product displayed in a print advertisement in a print media source, said instructions being arranged to cause one or more processors upon execution thereof to perform the steps of
receiving electronic indications about the product in reference to a reproduction of the print advertisement;
receiving user data;
